(19) United States
(12) Patent Application Publication
(10) Pub. No.: US 2017/0293946 A1
(43) Pub. Date: Oct. 12, 2017

(54) REALTY MODIFICATION ASSESSMENT

(71) Applicant: Mazin Badawi, Falls Church, VA (US)

(72) Inventor: Mazin Badawi, Falls Church, VA (US)

(73) Assignee: Mazin Badawi, Falls Church, VA (US)

(21) Appl. No.: 15/096,236

(22) Filed: Apr. 11, 2016

(51) Int. Cl. G06Q 30/02; G06F 17/30; G06Q 50/16

(52) U.S. Cl. CPC G06Q 30/0278; G06Q 50/16; G06F 17/30241

(57) ABSTRACT

The present invention includes a process and system for assessing home modifications. The assessment may relate to value or risk. A formatted realty schematic database retains electronically modifiable database that uses a gateway both to provide and receive realty fixture information to third parties.

### FIELD OF THE INVENTION

The present invention relates to the field of home construction and modification and more specifically to the field of home assessment.

### BACKGROUND

Houses can be black boxes for many purposes. Considering that a house is often the greatest investment that a natural person may consummate, the mysterious nature of a house's history can problematic. Frequently repeated repairs bespeak systematic problems, amateur repairs can be shoddy or even dangerous, and unlicensed service providers can offer standards below those of even amateurs; and whether any of these considerations are applicable to a house buyer cannot be readily ascertained in existing records. Furthermore, the owner of realty may simply want to make and access records related to the existence of a house. Therefore, there is a need for a process and system that reliably retains records related not only to realty, but portions thereof.

### SUMMARY

The present invention includes a system and process for a realty modification assessment. The system and process ingests native realty schematics related to real property fixtures. The realty schematic information is formatted to work with the system and process to include (i) location metadata and (ii) an electronic representation of fixtures, as a formatted realty schematic in a formatted realty schematic database stored in a search engine indexable nontransitory computer-readable storage medium. A gateway is provided for the bilateral transmission of data over a Wide Area Network, including: an outgoing gateway for the transmission of fixture representations correlated to location metadata from the formatted schematic database to an exterior third party, and an incoming gateway for the transmission of updated fixture representations from an exterior third party to the formatted schematic database correlated to location metadata.

These aspects of the invention are not meant to be exclusive. Furthermore, some features may apply to certain versions of the invention, but not others. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 is a view of the process and system of the present invention.

FIG. 2 is a view of the system of the present invention.

FIG. 3 is a view of the process of the present invention.

FIG. 4 is a view of the computer ecosystem of the present invention.

FIG. 5 is a view of the computer ecosystem of the present invention.

### DETAILED DESCRIPTION

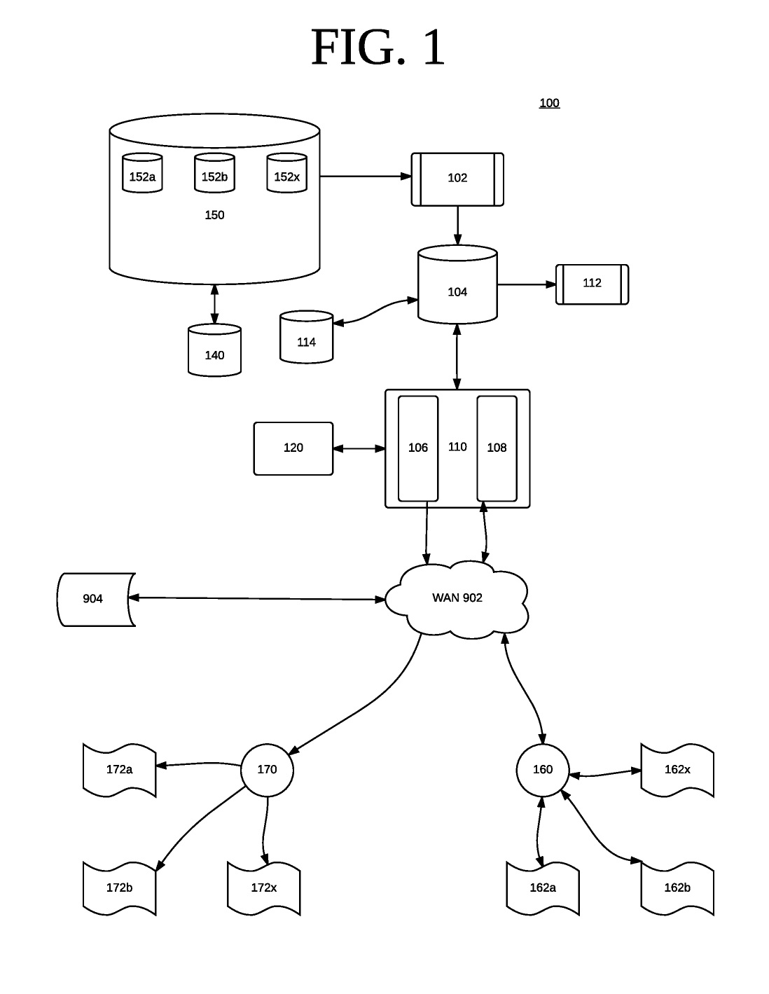

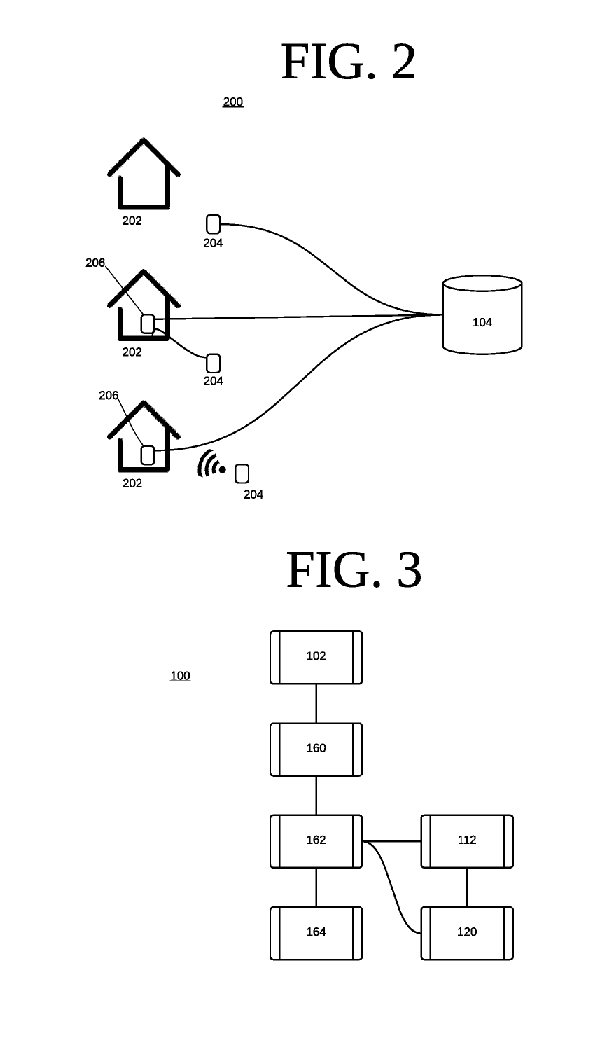

Referring first to FIGS. 1-2, a basic embodiment of the realty assessment process 100 is shown. Realty 202 according to the present invention encompasses both land and the dwelling attached thereto. Realty can be characterized in numerous ways, usually by means of a physical or electronic schematic, usually in “blueprint” form, corresponding to details of the realty. Schematics include any visual aids used by architects, construction workers, designers, and consumers to see how their modifications to realty will appear when completed. Drawn to scale, schematics permit designers and property owners to represent the realty before, during, and after construction. Examples of realty schematics include roomplans, electrical diagrams, plumbing diagrams, topographical land maps, etc. Realty schematics are available in public and commercial databases 150. Examples of realty schematic sources include municipalities (e.g., tax assessment divisions, licensing/zoning/permit divisions, etc.) 152a, builders/remodelers 152b, and other realty schematic sources 152x. These sources are likely to possess realty schematics in their native format, wherein the representations on the schematic exists purely for the purpose of demonstrating the features on the realty schematic.

These native format realty schematics are ingested 102 from the public and commercial databases and placed into a proprietary database 104. The proprietary database 104 exists to both aggregate realty schematics as well format them into searchable, flexible, and modifiable schema. Search engine indexing collects, parses, and stores data to facilitate fast and accurate information retrieval. Index design incorporates interdisciplinary concepts from linguistics, cognitive psychology, mathematics, informatics, and computer science. The purpose of storing an index is to optimize speed and performance in finding relevant documents for a search query. Without an index, the search engine would scan every document in the database, which would require considerable time and computing power. Furthermore, most documents that depict realty components tend to exist as physical documents that are only convertible to digital representations through manual translation. Furthermore, the availability of a digital version of a realty schematic does not guarantee flexibility for use with an electronic system. The translation of a realty schematic pursuant to the present invention may include: incorporation of vector-line drawings; incorporation of raster images; providing alphanumerics related to fixtures; and providing codes related to the quality, quantity, arrangement, orientation, color, and interrelationship or fixtures.

For example, a base physical realty schematic may be translated to a digital vector realty schematic. Preferably the inclusion of any realty schematic is accompanied by search engine indexable alphanumerics characterizing fixtures. For purposes of the present invention a fixture includes any thing, item, or feature that is attached to land, or shelter upon land, for use for an indefinite time period with the land. The term fixture further includes portions of dwelling. An example of fixtures according to the present invention include walls, toilets and other sanitary items such as sinks and bidets, counters, floors, garage door openings, heating/cooling units, electrical wiring, pipes, refrigerators and other appliances, and organic items such as trees and bushes. It is preferred that the present invention convert base realty schematics, such as blueprints, to an entirely alphanumeric-based system of fixture representation wherein the location, orientation, elevation, color, quality, and size of a fixture are converted to one or more codes. The codes may be fed to a translation device that reconstructs them for a pictorial representation of the realty schematic. The manipulation of a native realty schematic, i.e., a realty schematic lacking information directly usable by an alphanumeric based system of search and modification, to a schematic capable of manipulation by the present invention results in a formatted realty schematic.

The formatted realty schematic may be associated with metadata related to the realty. A preferred form of metadata includes location metadata, such as a physical address of the realty or geolocation coordinates. Other metadata may include the alphanumeric fixture representation codes, names, schools, taxation information, realty or fixture value, etc.

The database 104 is in signaled communication, preferably over a closed local area network (LAN) with a gateway 110 with the wide area network (WAN) 902, e.g. the Internet, distribution of the formatted realty schematics. The gateway 110 comprises two components, an outgoing gateway 106 and an incoming gateway 108. The incoming gateway 108 permits provides an informational network service 160 to entities seeking information on realty and fixtures therein, and may in certain instances modify the same. By an incoming gateway, it is meant that the gateway accepts incoming data for use in the database 104. The incoming gateway 108 may further include outgoing data functionality, and in preferred embodiments, does just that. Incoming data of the present invention allows home modification 162a, realty inspection 162b, and other entities 162x that analyze or modify realty to supply data to the present invention. These third parties 162x may access to the database 104 of the present invention to review or modify the formatted realty schematics.

In one version of the present invention, a third party 162x may review the interior of a house and generate a series of electronic fixture representations. These fixture representations may be transmitted to the database 104 in order to modify and grade the accuracy of formatted realty schematics within the database. A grader 112 permits grading an accuracy of at least one fixture representation based on a comparison of a native realty schematic to an updated fixture representation. An updated fixture representation is a fixture representation supplied subsequent to the input of a native realty schematic as a formatted realty schematic that applies to one or more fixtures. The updated fixture representation replaces the fixture representation as it contemporaneously exists in the database 104 for the formatted realty schematic. For example, if a plumber 162x installs a new toilet in a house corresponding to a particular formatted realty schematic, the plumber might access the database 104 to supply the brand, color, power rating, and liquid volume rating of the new toilet as an updated fixture representation. If the pre-existing formatted realty schematic included a toilet corresponding to that location in the house, because it was replaced and not added, then the formatted realty schematic replaces the existing reference to the prior toilet with the updated fixture representation corresponding to the new toilet.

The preferred transmission of an updated fixture representation includes both a present state value and a past state value. Whereas the present state value corresponds to the realty modification as applied at the time of modification or supplementation, the past state value corresponds to the fixture's state prior to the modification or supplementation. The grader 112 of the present invention may grade any aspect of the realty, but one of the aspects of the present invention is to provide quality assurance. In providing a past state and a present state, the past state of a fixture can be compared with the state of the same fixture in the formatted realty database 104. If the past state of a fixture is equivalent to the database state of the fixture, then there exists a validated chain of custody for fixture installation. A grade comprising alphanumerics, “100%” or “validated,” may be applied to fixtures with a validated chain of custody. By a validated chain of custody, it is meant that a line of fixtures can be completely accounted for from the fixtures present in the native realty schematic, or other frame of reference, to the present state of the fixture. If there are gaps in the chain of custody, then the chain of custody may be ‘not valid.’ Gaps in the chain of custody of the fixtures may exist if there is a difference between the past state of the fixture and the state of the fixture as saved in the database 104. Based on the type of fixture, and a date difference applied to the native realty schematic and the date of the updated fixture representation, the grader 112 may provide an estimate of the number of fixtures that have been replaced in the interim. The failure to have a validated chain of custody may imply that unlicensed or amateur repairs/modifications were applied to a dwelling and could adversely affect the value of the realty, and could increase the risk applicable to the realty. The risk assessment may be another grade applicable to the grader 112 of the present invention such that the grader may provide an estimate based on the fixture lacking a chain of custody, and the potential damage that could result from amateur construction. For example, for a toilet lacking a clear chain of custody, the grader 112 may calculate risk based on leaking bathroom pipes, overflowing toilet seepage, improper caulking, etc.

The present invention provides a credentials database 114 that permits authorized service providers to manipulate data within the formatted realty schematic database 104. Service providers of the present invention may include any professional or tradesman that builds, modifies, reviews, or otherwise works with fixtures as defined herein. Exemplary service providers of the present invention include: carpenters, plumbers, drywallers, masons, electricians, energy efficiency experts, floorers, painters, ductworkers, HVAC tradesmen, home inspectors, etc. Service providers may be vetted and onboarded into the credentials database which may include the identity of the service provider correlated to an electronic ID key. Other aspects of the service provider may be stored in the credentials database 114 as well, including repair histories, exterior service grades (e.g., BBB or Angie's List), warranty information, etc. The key of the present invention includes a unique credential set associated with the service provider, preferably a passcode and identifier. The service provider may access the gateway 110 over the WAN 902, at which point a firewall requires presentation of credentials, that if accepted, permit the service provider to access the formatted realty schematics database 104. The service provider 162x may review the formatted realty schematics or provide updates thereto.

The outgoing gateway 106 provides an informational network service 170 to entities seeking information on realty and fixtures therein. The outgoing informational network service 170 may provide formatted realty schematic access, as well as access to other services provided by the present invention, to make decisions related to realty. Examples of entities that may desire access to the formatted realty schematics include realtors and home inspectors 172a, insurance auditors and taxation authorities 172b, and other miscellaneous reviewers of realty information 172x. The credentials of the reviews of realty information 172x, do not necessarily need to adjust the fixtures of realty in the performance of their duties. However, these entities 172x may desire to change the fixtures as reported in the formatted realty database to conform to the fixtures as they actually exist in the realty. In such instances, the entity 172x would be allowed incoming gateway 108 access. The outgoing gateway permits credentialed access to the formatted realty schematic database 104 that allows outgoing transmissions. Credentials are stored in the credentials database 114.

The present invention further includes a scouring agent 120 for scouring search engine indexable documents 904 on the Internet or other WAN 902. When used in the present invention, the scouring agent 120 and the act of scouring 120 are meant to be synonymous, the agent being the code embodiment of the act of scouring. The scouring agent 120 has access to the Internet may directly spider websites or utilize the spidering efforts of a commercial search engine, e.g., GOOGLE or YAHOO. By scouring a WAN for documents 904 indicating fixtures, the present invention can perform a variety of beneficial actions. In one aspect of the present invention, the grader 112 can examine the fixtures as characterized by a WAN document 904 to provide an accuracy commentary on the formatted realty schematics within the database 104. Furthermore, the present invention may grade 112 the accuracy of WAN documents 904 that characterize fixtures. For example, realty valuation websites posts url documents that purport to estimate the value of realty, usually with a listing of fixtures applicable to the realty. Here, the grader may compare the fixtures as indicated on the url and the fixtures known to the formatted realty schematics in the database 104 to grade the accuracy of the realty value of the url. The accuracy grades may include quantifiable value alterations (e.g., +$20,000.00 or −$5,000.00 or +/−$3,000.00) or simply qualitative alterations (e.g, “falsely high” or “falsely low”). The accuracy grades may be made available to websites that characterize realty and fixtures through the outgoing gateway so supplement the WAN documents 904, or the accuracy grades may be made available directly over the WAN to a viewer on a document distinct from the applicable WAN document 904.

The present invention further includes providing for the transmission of updated fixture representations from a static transmission unit 206, affixed to realty 202, capable of WAN transmission correlated to the location metadata of the formatted realty schematic. By static transmission unit 206, it is meant an electronic communication device indefinitely associated with realty. As dwellings are becoming more and more communication oriented, there are multiple devices by which a communication can validate the source of fixture repair as well as provide information on the fixture repair. The static transmission unit may be a device custom-made for the present invention, or be an add-on to a pre-existing communication device associated with realty, e.g. smart meters, meters, routers, cable boxes, and the like. The static transmission unit is provided with a program that communicates directly with the database 104 in a manner that provides credentials of the realty, which may or may not be stored in the credentials database 114. The transmission may further include the updated fixture representation, or a token or other piece of validation, that corroborates a separate transmission. In a preferred version of a system 200 that utilizes the static transmission unit, a service provider 162x utilizes a mobile transmission unit 204 bearing a Service Provider Interface and key, preferably from the credentials database 114, to provide the updated fixture representation. The mobile transmission unit 204, which may include any form of mobile electronic communications device (e.g., smartphone, tablet, PDA, RFID fob, etc.). The mobile transmission unit 104 may include a physical key or electronic key that validates the service provider through validation from the credentials database 114. When a service provider adds or modifies a fixture, the service provider may communicate through the mobile transmission unit to the database 104 the updated fixture representation. The transmission may occur from the mobile transmission unit directly to the gateway 110 with an ancillary transmission to the static transmission unit for the purposes of validating the location of the construction/repair. Here, the transmission between the static transmission unit and the mobile transmission unit is local to support the passing of credentials from the realty to the mobile transmission unit (e.g., location validation) or vice versa (e.g., persistent record retained by the realty). The transmission may occur from the mobile transmission unit to the static transmission unit to the gateway. The transmission may include any means known in the art, include transmission-by-wire or airborne transmission (including radio waves).

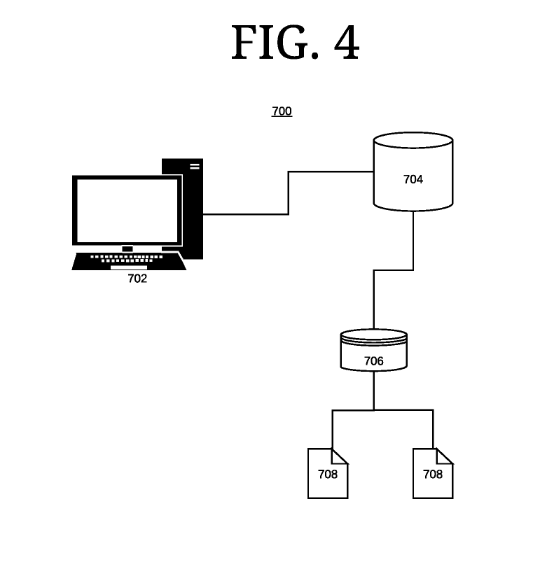

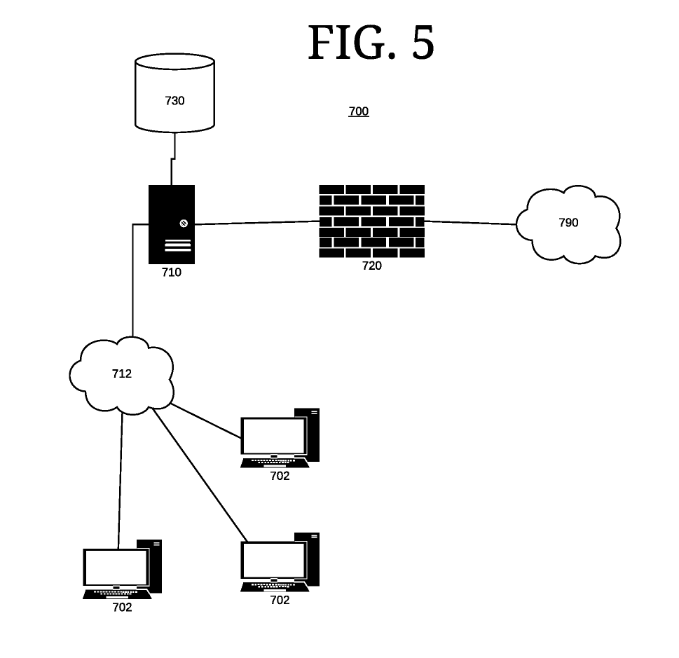

The inclusion of location credentials and service provider credentials further increases the security and accuracy of the present invention, which relies on computer ecosystems. FIGS. 4-5 depict a computer ecosystem 700 of the present invention. By ecosystem it is meant one or more computers 702 that are organizationally related. The ecosystem may include computers under common ownership, computers that belong to the same network or series of networks, computers that are collaborating, etc. The present invention may be provided as a computer program product, or software that may include a computer-readable storage medium 704 having stored thereon instructions, which may be used to perform the process of the present invention across a computer ecosystem 700 according to the various embodiments disclosed herein.

A computer 702 of the present invention may include any combination of one or more computer readable media 704. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium 704 may be any tangible medium that can contain, or store a program for use by or in connection with an instruction execution system, apparatus, or device.

A computer readable signal medium 704 may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks. The flowchart and block diagrams in the figures described below illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Furthermore, the functionality of one block may be subsumed by the functionality of another block as a substep thereof. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. An ecosystem 700 may further include a computer network or data network that allows computers to exchange data. In a computer network of the present invention, networked computing devices pass data to each other along data connections. The connections between nodes are established using cable media, wireless media, or other media. The Internet or other exterior network 790 may be a component of the ecosystem 700. Nodes may include hosts such as personal computers, phones, servers, and networking hardware. Two such devices are networked together when one device is able to exchange information with the other device, whether or not they have a direct connection to each other. Computer networks of the present invention support applications such as access to the World Wide Web, shared use of application and storage servers, printers, and fax machines, and use of email and instant messaging applications. Computer networks may be included irrespective of the physical media used to transmit their signals, the communications protocols to organize network traffic, the network's size, topology, and organizational intent.

It is preferred that the network of the present invention have at least one boundary 720, and potentially multiple boundaries if a demilitarized zone is utilized. The boundary 720 may include any number of layers designed to regulate and secure the flow of information between networks. Boundary layers of the present invention may include enterprise content management software, firewalls, filters, threat management software, alarms, etc. Software for establishing a boundary may be run on a server 710 with server storage 730 of the present invention, which may include directory services controlling access credentials.

To combat security risks posed by network connections, firewalls are frequently used. A firewall may be a hardware or software component that filters network traffic so that communications with unauthorized third parties are blocked but legitimate network functions may be carried out. Frequently, the filters applied by a firewall are specified by a set of policies defining characteristics of network messages that either should pass through the firewall or that should be blocked. Because different levels of communication may be appropriate depending on the origin or destination of messages, firewall policies may be provided for each application that executes on a computing device and communicates over a network.

A firewall may have an outward side facing a global network, such as the Internet. The opposite side of the firewall may be a private network that is protected by the firewall. The private network may include any number of host machines (e.g., computers) each addressable by its own IP address. The physical construction of the network may be such that all data packets intended for one of the IP addresses behind the firewall pass through the firewall. Using the firewall rules, which may be set by a network administrator or other user, the firewall may determine whether to allow or deny certain data packets and/or determine where to route particular data packets based on the IP addresses to which the packets are directed. The determination of where to route data packets may be done using the IP addresses of the host machines in the private network.

Depending on the addressing scheme used by the network, the IP addresses of the host machines may be static or dynamic. Static IP addresses do not change over time, and thus once they are set in the firewall rules, there is no need to update them. The Internet Protocol version Four (IPv4) addressing system commonly uses static addressing, while IPv6 may use dynamic addressing. Dynamic IP addresses may change over time and thus, there is a need to update the firewall rules as changes occur. When a small Local Area Network (LAN), such as a domestic network in a private residence, is linked to a larger network such as the Internet, the link is often through a gateway router acting as a firewall. One of the functions of the firewall is to protect the LAN from intrusion from outside.

A service directory accessible by a server 710, usually on server storage 730, stores information about network resources across a domain. An example of a directory service is Active Directory. The main purpose of Active Directory is to provide central authentication and authorization services for Windows-based computers. Active Directory also allows administrators to assign policies, deploy software, and apply critical updates to an organization. Active Directory stores information and settings in a central database.

An Active Directory structure is a hierarchical framework of objects. The objects fall into three broad categories: resources (e.g. printers), services (e.g. e-mail) and users (e.g., user accounts and groups). The Active Directory provides information on the objects, organizes the objects, controls access and sets security. Certain objects can also be containers of other objects. An object is uniquely identified by its name and has a set of attributes—the characteristics and information that the object can contain—defined by a schema, which also determines the kind of objects that can be stored in the Active Directory.

Typically, the highest object in the hierarchy is the domain. The domain can be further sub-divided into containers called Organizational Units. Organizational units give a semblance of structure to the organization either based on administrative structure or geographical structure. The organizational unit is the common level at which to apply group policies, which are Active Directory objects themselves called Group Policy Objects. Policies can also be applied to individual objects or attributes as well as at the site level (i.e., one or more IP subnets).

The present invention may use one of more communication networks to foster information exchange throughout the computers of the ecosystem. Communication networks might either be private or public. In a private network, communications between multiple computers occur in a secure environment that prevents access from outside the network without appropriate authentication. These networks are considered as “trusted” networks because the communication signals securely travel from one computer to another within the private network without being exposed to the external environment.

Public networks such as the Internet, on the other hand, are not secure because the communication over these networks is not private and is susceptible to interception by other computers. In addition, the public networks cannot guarantee the delivery of the data packets being sent. They allow packets to be injected into, or ejected out of, the networks indiscriminately, and analyzed while in transit. To keep data sent over a public network private, a Virtual Private Network (VPN) is commonly established on top of a public network when two computers use the public network to communicate with each other. In a Virtual Private Network, data sent from one computer to another is encrypted by a security gateway and transmitted in encrypted form over the public network to a second security gateway connected to the receiving computer. The second gateway decrypts the data before forwarding it to the receiving computer. Such a private channel established on top of another network is referred to as a network tunnel.

In order to set up a Virtual Private Network, a user first establishes a path to a VPN server and goes through an AAA process (Authentication, Authorization and Accounting) for identification and authorization to create a secure tunnel with the server. Once the user is authorized, a secure network tunnel is established between the user and the VPN server over the public network, using a VPN protocol such as IPsec. This process requires a VPN client on the user's side, a VPN server and other VPN hardware on the other side of the tunnel, as well as appropriate user configurations.

Today's private networks often include wireless networks such as WiMAX to accommodate mobile access. In addition, to provide mobility access in a large geographic area, a private enterprise often relies on third-party wireless infrastructures besides its own wireless network. In this case, a user's device would need to be authenticated by both a third-party gateway and an enterprise authentication server before it could access the enterprise network. User credentials are typically requested by and securely returned to the third-party gateway. Once the user is authenticated and authorized, the user may communicate with the third-party wireless gateway.

The present invention includes files 708, which may include executable instructions by which the present invention runs, or files upon and with which the present invention interacts. Example files of the present invention include the formatted realty schematics, or they may be aggregated as data forms within a single file. The documents may be on local storage 704 or shared storage 730 and be created, accessed, edited, and/or otherwise modified using any of a number of applications, including for example and without limitation Final Cut Pro, Avid, Microsoft Office applications (Word, Excel, Power Point, Outlook, Visio, etc.), Adobe Reader or Acrobat, AutoCAD, SolidWorks, or any other suitable document editing application. The content of the documents may be audio tracks, video clips, images, word processing documents, presentations, spreadsheets, business documents, engineering documents, databases, etc.

Returning to FIG. 1, the present invention further includes an environmental database 140. By environmental database, it is meant a database that stores environmental information related to the property. Property degradation can be based on multiple sources other than the inherent construction traits of the house. The use of the grader 112 to apply environmental information from the environmental database applicable to the property and generate an opinion provides a host of useful information to an entity. Earthquakes have the capacity to injure the foundation of a house; excessive rain results in the rapid deterioration of paint and wood fixtures (e.g., decks, fences, etc.); proximity to mills that emit sulfur into the air in mass quantities results in corroded metals; snow accumulation weakens roof structures; etc. There are repair benchmarks for the maintenance and upkeep of houses, but they are only that, benchmarks. The application of environmental effects to a property, or a region containing properties, can result in a grade for the expected quality of a property or subcomponent thereof. For example, if a repair benchmark for a house's roof in a particular area is 20 years, yet that area has experienced triple the usual amount of snowfall, then a purchaser of a house with an 18-year-old roof should expect to factor roof replacement into her purchasing consideration. The environmental database can store types of information related to non-inherent structural data. Inherent structural data includes such information as is associated with the attributes of the property's construction material, for example wood type or paint ingredients, while an environmental information type can include any condition that affects the construction material, for example unusual termite activity in a region or nearby ordinance testing. The environmental data may be obtained by the scouring agent 120, or may be applied from proprietary third party databases (e.g., almanac services).

Environmental conditions are not necessarily stored on a property-by-property basis. Instead, environmental conditions are stored on a region basis for later application to one or more properties. The environmental conditions may be stored regionally based on country, state, geographic features (e.g., Appalachian mountains or Chesapeake watershed), zip codes, neighborhoods, etc. Any level lower than the region level should simply be stored as a ‘history’ of the particular property. As the property database may include such data points as state and zip code, and preferably geographic regional traits (e.g. Chesapeake watershed), the environmental conditions are readily applied based on a data type comparison. As the present invention may provide qualitative grades or recommendations related to fixtures of the properties, e.g. “good”, “bad,” “compliant,” “replace,” “replace in [x] years,” the information may be adjusted based on a history of environmental conditions applicable to the region in an attempt to estimate the existing of specific fixtures. Certain environmental conditions will be applicable to one fixture, but not another, or more intensely related to one fixture and minimally to another. The present invention includes a correlation that applies, for example, precipitation effects to a fence and grass, but not to internal stairs.

The grader may take into account modifications for the property that offset or counteract the presence of environmental conditions. For example, records of service applications whereby a service provider applies water sealant to a fence may completely or wholly offset the otherwise negative effects of heavy periods of precipitation. A fence may have a natural life of fifteen years on a particular region. Excessive precipitation may result in the present invention downgrading the life of the fence to twelve years, whereas the regular application of water seal by an accredited service provider may increase the longevity to the natural life or beyond. This information may be provided to a realtor, buyer, or service provider.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A realty assessment process, said process comprising:
ingesting a native realty schematic having information related to real property fixtures;
formatting said realty schematic, to include (i) location metadata and (ii) an electronic representation of fixtures, as a formatted realty schematic in a formatted realty schematic database stored in a search engine indexable nontransitory computer-readable storage medium; and
providing a gateway for the bilateral transmission of data over a Wide Area Network, including: an outgoing gateway for the transmission of fixture representations correlated to location metadata from said formatted schematic database to an exterior third party, and an incoming gateway for the transmission of updated fixture representations from an exterior third party to said formatted schematic database correlated to location metadata.

2. The process of claim 1 further comprising the step of grading an accuracy of at least one fixture representation based on a comparison of said native realty schematic to said updated fixture representation.

3. The process of claim 1 wherein said providing step includes providing a gateway for the transmission of updated fixture representations comprising a present state value and a past state value.

4. The process of claim 3 further comprising the step of grading an accuracy of at least one fixture representation based on a comparison of said native realty schematic to said updated fixture representation.

5. The process of claim 1 further comprising scouring third-party WAN realty information correlated to said location metadata, and calculating a confidence value for realty corresponding to said location metadata.

6. The process of claim 1 further comprising validating said updated fixture representation via an authorized service provider database, said database comprising vetted identities correlated to an electronic ID key.

7. The process of claim 6 wherein said providing step includes providing a gateway for the transmission of updated fixture representations from a static transmission unit, affixed to realty, capable of WAN transmission correlated to said location metadata.

8. The process of claim 7 further wherein said validating step includes validating said updated fixture representation via a mobile transmission unit bearing a Service Provider Interface and said key, in signaled transmission with said static transmission unit for the transmission of said updated fixture representation from said mobile transmission unit to said static transmission unit to said formatted realty schematic database.

9. The process of claim 1 further comprising the step of grading a quality of a fixture representation based on an application of a regional environmental condition history stored in an environmental database.

10. A realty assessment system, said system comprising:
realty comprising multiple fixtures therein;
a formatted realty database, stored in a nontransitory computer-readable storage medium, comprising formatted realty schematics comprising (i) location metadata and (ii) an electronic representation of fixtures, as a formatted realty schematic; and
a gateway for the bilateral transmission of data over a Wide Area Network, including: an outgoing gateway for the transmission of fixture representations correlated to location metadata from said formatted schematic database to an exterior third party, and an incoming gateway for the transmission of updated fixture representations from an exterior third party to said formatted schematic database correlated to location metadata.

11. The system of claim 10 further comprising a grader for grading an accuracy of at least one fixture representation based on a comparison of said native realty schematic to said updated fixture representation.

12. The system of claim 10 wherein said gateway includes a gateway for the transmission of updated fixture representations comprising a present state value and a past state value.

13. The system of claim 12 further comprising a grader for grading an accuracy of at least one fixture representation based on a comparison of said native realty schematic to said updated fixture representation.

14. The system of claim 10 further comprising a scouring agent for scouring third-party WAN realty information correlated to said location metadata, and calculating a confidence value for realty corresponding to said location metadata.

15. The system of claim 10 further comprising a validation engine for validating said updated fixture representation via an authorized service provider database, said database comprising vetted identities correlated to an electronic ID key.

16. The system of claim 15 further comprising a static transmission unit, affixed to realty, affixed to said realty, for the transmission of updated fixture representations therefrom, capable of WAN transmission correlated to said location metadata.

17. The process of claim 16 further comprising a mobile transmission unit bearing a Service Provider Interface and said key, in signaled transmission with said static transmission unit, for validating said updated fixture representation via a for the transmission of said updated fixture representation from said mobile transmission unit to said static transmission unit to said formatted realty schematic database.

18. The system of claim 10 further comprising a grader for qualitatively grading at least one fixture representation based on an application of a regional environmental condition history stored in an environmental database.
